(19) United States
(12) Patent Application Publication
(10) Pub. No.: US 2008/0207364 A1
(43) Pub. Date: Aug. 28, 2008

(54) Driving pulley with vibration damping means

(76) Inventors: Michael Schebitz, Attendorn (DE); Matthias Zacker, Attendorn (DE); Stefan Schattenberg, Attendorn (DE)

Correspondence Address: Wyatt, Gerber & O'Rourke, LLP, 99 Park Avenue, New York, NY, 10016, US

(21) Appl. No.: 12/070,098

(22) Filed: Feb. 18, 2008

(30) Foreign Application Priority Data
Feb. 16, 2007 (DE) 102007008282.9-27

(51) Int. Cl. F16F 15/123

(52) U.S. Cl. 474/94

(57) ABSTRACT

A driving pulley is provided having a pulley rim and a hub which are rotatably supported inside one another, and having spring means which are mounted between the pulley rim and the hub and whose one end is fixed relative to the pulley rim and whose other end is fixed relative to the hub in the direction of rotation, wherein the spring means consist of spiral or helical springs which are effective in opposite directions.

### SUMMARY OF THE INVENTION

The invention relates to a driving pulley having a pulley rim and a hub which are rotatably supported inside one another, and having spring means which are mounted between the pulley rim and the hub and whose one end is fixed relative to the pulley rim and whose other end is fixed relative to the hub in the direction of rotation. Driving pulleys are described in the applicant's earlier publication DE 10 2005 055 034 B3. Driving pulleys of this type serve in the form of belt pulleys for the purpose of transmitting torque in belt drives, more particularly for driving auxiliary units of internal combustion engines.

Due to an increase in combustion pressures in typical internal combustion engines the rotational non-uniformity of the crankshaft increases. As a result, there is generated an increase in the load in the belt drive for the auxiliary drives, which belt drive is driven by the crankshaft. The load level is primarily determined by the mass inertia of the generator.

In today's internal combustion engines, a non-uniform drive of the crankshaft, changing load conditions of the auxiliary units and the elasticity of the belt can generate a highly dynamic vibration system in the auxiliary drive i.e. in the belt drive for driving the auxiliary units from the crankshaft. Accordingly, it is an object to provide that the nominal performance values of the auxiliary units increase constantly.

Relative to the driven pulley of the crankshaft, the generator input pulleys are very small, so that the transmission ratio and thus the rotational speed of the generator are very high. It is not uncommon practice for the generator to be designed for maximum rotational speeds of 18,000 min⁻¹ because the required performance can only be achieved by a high number of windings and/or high rotational speeds of the generator. Even at low engine speeds, such a generator has to have a high rotational speed, which makes it necessary to provide a ratio of at least 6:1 between the rotational generator speed and the engine speed.

During the delay phases of the rotational non-uniformity of the crankshaft, the high inertia of the generator with the high rotational speed, leads to considerable forces in the belt drive leg and to an increased inclination to slip, so thereby increasing belt wear at each combustion cycle. The high mass inertia prevents the generator from following the partly high-frequency changes in speed, and elongation and/or slip in the belt drive occurs leading to disadvantageous loads.

It is therefore an object of the present invention to provide driving pulleys which ensure the disconnection of vibrations within the belt drive.

A device according to the invention includes spring means comprising spiral springs or helical springs which are effective in opposite directions, wherein at least one end of a spring is coupled in a rotationally fast way to the pulley rim and an other end of the spring is coupled in a rotationally fast way to the hub. In such an embodiment, only elastic rotational disconnection between the crankshaft and the generator can occur, both for the delay phase and also the acceleration phase, and without a complete disconnection of the transmission of torque. However, in the case of an overload, a complete disconnection can take place.

According to a preferred embodiment, a device having flat spiral springs is provided which springs can be arranged next to one another in the axial direction and which can be pretensioned relative to one another. Alternatively, a device having helical springs can be provided which springs can be arranged next to one another in the axial direction and which springs can be pretensioned relative to one another.

In accordance with the above-mentioned solution, a decoupler is provided which permits a coupling between the crankshaft and the generator in both directions of torque transmission. In addition, the decoupler provides a coupling that is elastic in both directions of rotation, but which, as a result of the inventive connection between the pulley rim and the hub, reduces the extent of the rotational non-uniformity which is transmitted by the belt drive to the generator shaft.

According to another embodiment, a device is provided having springs connected to an inner face of the pulley rim which can be connected entirely by force locking and/or friction locking, with the outer spring ends resting with a radial pretension against a cylindrical inner face of the pulley rim. During a rotation of the pulley rim relative to the hub, one of the springs can expand, whereby the contact forces at this one spring can increase, and as a consequence a disconnection of the force locking or friction locking connection, at least of this spring, is prevented under normal operational conditions.

According to another embodiment, a device is provided having springs which can be connected to an outer face of the hub by force locking and/or friction locking, with the inner spring ends resting with a radial pretension against a cylindrical outer face of the hub. As one of the springs contracts during a relative rotation of the pulley rim and hub, the contact forces can increase at this particular spring, whereby the force or friction locking connection of at least this spring can be prevented under normal operating conditions.

According to another embodiment, a device is provided having springs first ends which abut rotary stops of the pulley rim in a positive and form-fitting way at first ends of the springs. In addition, or in the alternative their second ends can abut rotary stops at the hub in a positive and form fitting way at their second ends. A device according to the invention having the positive and form fitting connections increases the strength of the connection of the springs at the pulley rim and the hub while reducing construction effort.

A device according to the invention is provided having a simple design and a high degree of operational safety. Such a device is especially suitable for vehicles with diesel engines, with a double-mass flywheel and/or with automatic gearboxes with a high mass inertia. Such devices are increasingly in demand for petrol engines with high combustion pressures and a high performance of the auxiliary drives. Advantages of the inventive pulley rims include:

calming of the belt vibrations,

reduction in the travel of the belt drive tensioning device,

increase in the belt service life,

reduction in the force level at the belt drive and improved noise behaviour in the belt drive.

Overall, these effects allow the use of high-performance generators in present internal combustion engines.

### BRIEF DESCRIPTION OF THE DRAWINGS

Preferred embodiments of the invention are illustrated in the drawings and will be described below.

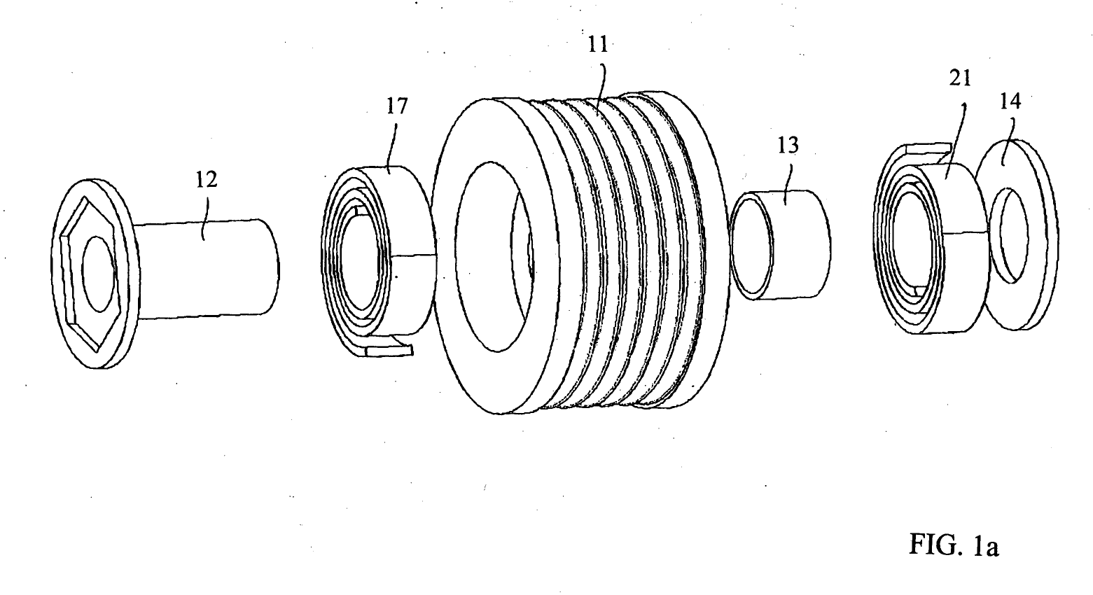

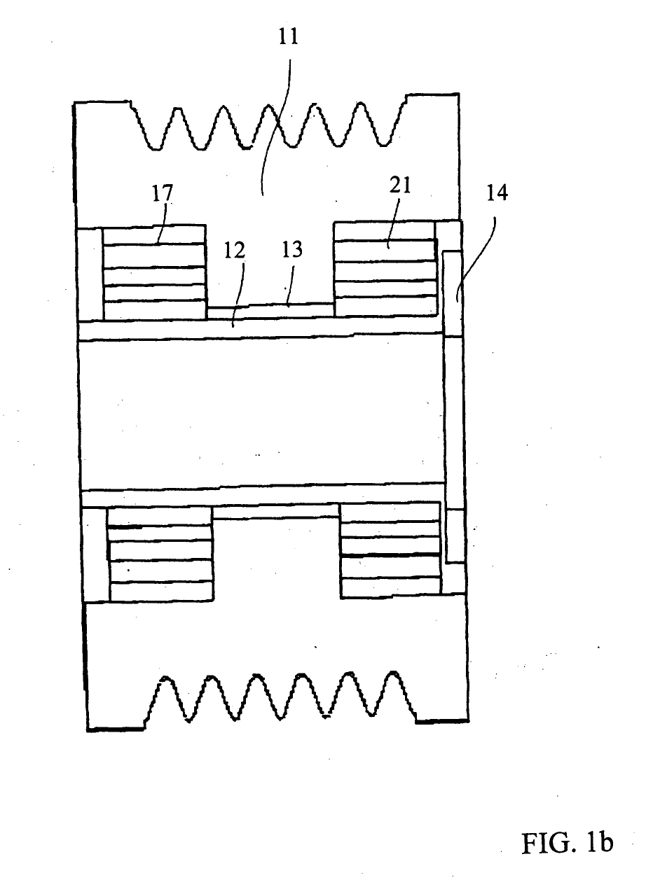

FIG. 1 illustrates a first embodiment of an inventive rotary vibration damper in the form of a decoupler
a) in an exploded view in a first perspective, and
b) in a longitudinal section.

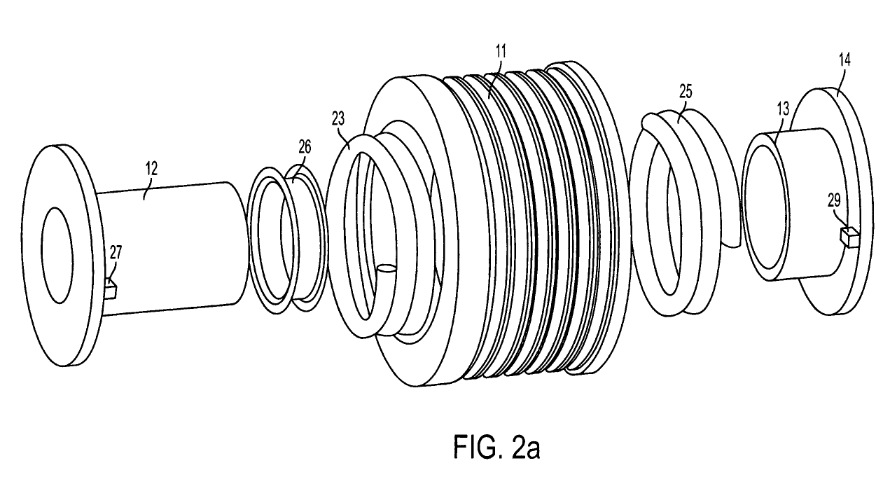

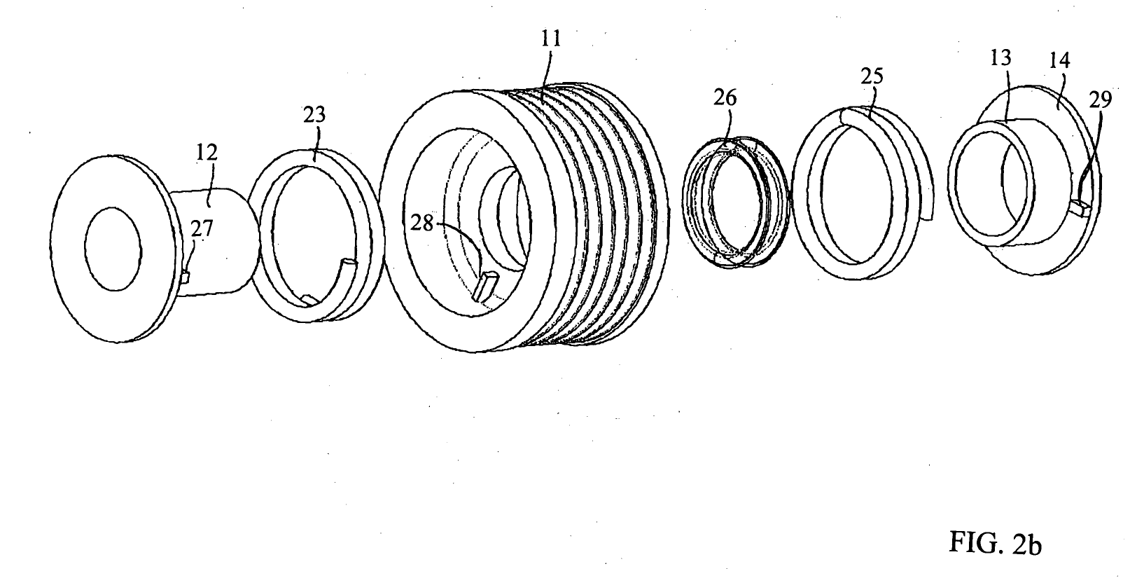

FIG. 2 illustrates a second embodiment of an inventive rotary vibration damper in the form of a decoupler
a) in an exploded view in a first perspective, and
b) in an exploded view in a second perspective.

### DETAILED DESCRIPTION

The individual illustrations are described below. FIG. 1 shows an inventive driving pulley with a rotary vibration damping assembly which comprises a pulley rim 11 for a poly-V-belt and a hub 12 which can be clamped to a generator shaft; the relative rotatable support between the two parts can be effected by a sliding sleeve 13. A disc 14 can be provided for axially mounting the assembly. An annular chamber can be provided between the pulley rim 11 and the hub 12, and two flat spiral springs 17 and 21 can be provided which can be wound in opposite directions, and which can be arranged next to each other in the axial direction. The springs can be secured at their radial inner ends in a force locking or form fitting way on the hub 12, and can be supported at their outer ends in a force locking or form-fitting way on the pulley rim 11. In a mounted condition, the two springs of a device according to the invention can be tensioned in opposite directions, as a result of which, when the pulley rim 11 and the hub 12 are rotated relative to one another, additional tension can be built up in one of the springs which can be reduced in the other one of the springs. When the pulley rim and the hub 12 are rotated relative to one another in the opposite direction, this process can be reversed. However, preferably there is no disconnection of one of the two flat springs from the pulley rim and the hub. Accordingly, an elastic spring movement is provided which is damped by internal spring damping.

As shown in FIG. 2, a rotary vibration damping assembly can be provided which comprises a pulley rim 11 for a poly-V-belt and a hub 12 which can be clamped to a generator shaft. A relative rotatable support can be provided between the two components by a sliding sleeve 13 among other things. A disc 14 can be provided which integrally adjoins the sliding sleeve 13 and serves for axially mounting the assembly. In an annular chamber between the pulley rim 11 and the hub 12, two helical springs 23 and 25 can be provided which are wound in the same sense. In addition, the springs can be arranged next to each other in the axial direction and whose axially outer ends can be supported in a positive and form fitting way on the hub 12 and on the disc 14 respectively. Further, the axially inner ends at the springs can be supported in a positive and form-fitting way on the pulley rim 11. At the hub 12 and at the disc 14, rotary stops 27, 29 can be provided. At the pulley rim 11 (such as shown in illustration b) one of the rotary stops 28 is shown. Between the springs a spacing element 26 can be provided. In the mounted condition, the two helical springs can be pretensioned in opposite directions. As a result of the sense of winding, when the pulley rim 11 and the hub 12 rotate relative to one another, an additional tension can be built up in one of the springs, whereas the tension can be reduced in the other one of the springs. If the relative rotation takes place in the opposite direction, the process can be reversed. However, preferably there is no disconnection of one of the two helical springs from the pulley rim and the hub. Accordingly, an elastic spring movement is provided which is damped by internal spring damping.

1. A driving pulley having a pulley rim (11) and a hub (12) which are rotatably supported inside one another, and having spring means which are mounted between the pulley rim (11) and the hub (12), said spring means having one end being fixed relative to the pulley rim (11) and another end being fixed relative to the hub (12) in the direction of rotation, wherein the spring means further comprise spiral springs (17, 21; 23, 25) or helical springs which are effective in opposite directions, said springs having at least one end being coupled in a rotationally fast way to the pulley rim (11) and at least one other end being coupled in a rotationally fast way to the hub (12).

2. A driving pulley according to claim 1, wherein the springs are flat spiral springs (17, 21) and wherein the springs are arranged next to one another in the axial direction, and are pretensioned relative to one another.

3. A driving pulley according to claim 1, wherein the springs are helical springs (23, 25) and wherein the springs are arranged next to one another in the axial direction, and are pretensioned relative to one another.

4. A driving pulley according to claim 1, wherein the pulley rim has an inner face and wherein the springs (17, 21; 23, 25) are connected to the inner face of the pulley rim (11) by force locking and/or friction locking.

5. A driving pulley according to claim 1, wherein the hub has an outer face and wherein the springs (17, 21; 23, 25) are connected to the outer face of the hub (12) entirely by force locking and/or friction locking.

6. A driving pulley according to claim 1, wherein the pulley further comprises at least one rotary stop, and wherein the at least one first ends of the springs (17, 21; 23, 25) abut rotary stops (28) of the pulley rim (11) in a positive and form-fitting way.

7. A driving pulley according to claim 1, wherein the pulley further comprises at least one rotary stop, and wherein the at least one other end of the springs abut rotary stops (27, 29) at the hub in a positive and form-fitting way.
